(19) United States
(12) Patent Application Publication
(10) Pub. No.: US 2023/0377318 A1
(43) Pub. Date: Nov. 23, 2023

(54) MULTI-MODAL IMAGE CLASSIFICATION SYSTEM AND METHOD USING ATTENTION-BASED MULTI-INTERACTION NETWORK

(71) Applicant: Shandong Jianzhu University, Jinan City (CN)

(72) Inventors: Xiaoming XI, Jinan City (CN); Xiao YANG, Jinan City (CN); Xinfeng LIU, Jinan City (CN); Xiushan NIE, Jinan City (CN); Guang ZHANG, Jinan City (CN); Yilong YIN, Jinan City (CN)

(73) Assignee: Shandong Jianzhu University, Jinan City (CN)

(21) Appl. No.: 18/110,987

(22) Filed: Feb. 17, 2023

(30) Foreign Application Priority Data
May 18, 2022 (CN) 202210536123.1

(51) Int. Cl. G06V 10/776; G06V 10/82; G06V 10/774; G06V 10/80; G06V 10/77

(52) U.S. Cl. CPC G06V 10/776; G06V 10/82; G06V 10/774; G06V 10/806; G06V 10/7715; G06V 10/809

(57) ABSTRACT

The present disclosure belongs to the technical field of image processing, and provides a multi-modal image classification system and method using an attention-based multi-interaction network. The present disclosure utilizes a U-net network structure to fuse low-level visual features and high-level semantic features. An attention network is introduced to solve the problem of weak feature discrimination, and high attention is given to discriminative features, so that the attention network plays an important role in the final classification process. A sufficient multi-modal interaction mechanism is introduced, so that more effective correlation information and discriminative information are obtained among a plurality of modalities, and sufficient interaction among the plurality of modalities is completed, thereby solving the problems of weak feature discrimination and insufficient interaction among modalities in a multi-modal image classification task.

### CROSS-REFERENCE TO RELATED APPLICATION

This patent application claims the benefit and priority of Chinese Patent Application No. 202210536123.1 filed with the China National Intellectual Property Administration on May 18, 2022, the disclosure of which is incorporated by reference herein in its entirety as part of the present application.

### TECHNICAL FIELD

The present disclosure relates to the technical field of image processing, and in particular, to a multi-modal image classification system and method using an attention-based multi-interaction network.

### BACKGROUND

Image classification is an important part of computer vision tasks, and is also a core task that has been widely studied in the field of vision. With the development of deep learning technology, the image classification task has made a substantial breakthrough, but there are still some drawbacks for some specific tasks. In image processing tasks based on deep learning, if image classification is performed using only unimodal data, the classification performance is difficult to achieve satisfactory results. For example, in auxiliary diagnosis of breast cancer, mammography image modality and ultrasound image modality have their pros and cons in terms of influencing the classification performance. Only using unimodal images will lead to poor classification performance, which is not conducive to clinical auxiliary diagnosis.

Due to excellent feature expression ability, deep learning has been widely used in the classification and recognition tasks of multimedia data such as images, videos, speech and so on. However, most existing deep learning methods ignore the sufficient interaction between modalities in multi-modal image fusion, which limits the improvement of image classification performance.

### SUMMARY

In order to solve at least one technical problem existing in the above background, the present disclosure provides a multi-modal image classification system and method using an attention-based multi-interaction network, which introduces a sufficient multi-modal interaction mechanism, so that more effective correlation information and discriminative information can be obtained among multi-modalities, and sufficient interaction among multi-modalities is completed.

In order to achieve the above object, the present disclosure adopts the following technical solutions.

A first aspect of the present disclosure provides a multi-modal image classification system using an attention-based multi-interaction network, comprising:

a feature vector extraction module configured to extract key feature information from multi-modal images;

a prior module configured to receive the key feature information, and calculate correlations among a plurality of modalities by using prior knowledge of the plurality of modalities, to obtain a first feature map set;

a channel interaction module configured to receive the first feature map set, and perform modality fusion on a plurality of features in the first feature map set in a channel dimension to obtain a second feature map set;

a modality fusion module configured to receive the second feature map set, model feature maps with correlation and fused modality to obtain features of attention areas of respective modalities, and calculate similarities based on the features of the attention areas of respective modalities to obtain a corresponding third feature map set;

an image classification module configured to classify the third feature map set based on a trained classification network model, and calculate corresponding class scores, wherein a class corresponding to a maximum value of the class scores is a final classification result.

A second aspect of the present disclosure provides a multi-modal image classification method using an attention-based multi-interaction network, comprising:

extracting key feature information from multi-modal images;

calculating, based on the key feature information, correlations among a plurality of modalities by using prior knowledge of the plurality of modalities to obtain a first feature map set;

performing, based on the first feature map set, modality fusion on a plurality of features in the first feature map set in a channel dimension to obtain a second feature map set;

modeling, based on the second feature map set, feature maps with correlation and fused modality to obtain features of attention areas of respective modality, and calculating similarities based on the features of the attention areas respective modalities to obtain a corresponding third feature map set;

classifying the third feature map set based on a trained classification network model, and calculating corresponding class scores, wherein a class corresponding to a maximum value of the class scores is a final classification result.

Compared with the prior art, the invention has the following beneficial effects:

By introducing a sufficient multi-modal interaction mechanism, more effective correlation information and discriminative information are obtained among a plurality of modalities, and sufficient interaction among the plurality of modalities is completed. Compared with traditional multi-modal classification methods, which focus on modality fusion and lack sufficient interaction between modalities, this method shows its superiority in image data classification.

The present disclosure utilizes a U-net network structure to improve the distinguishability of features. On the other hand, an attention method is introduced to give higher attention to robust modality features, so that the features play a more important role in final classification, which helps to improve the classification performance.

### BRIEF DESCRIPTION OF THE DRAWINGS

The accompanying drawings forming a part of the present disclosure are used to provide further understanding of the present disclosure, and exemplary embodiments of the present disclosure and their descriptions are used to explain the present disclosure, and do not constitute an improper limitation of the present disclosure.

FIG. 1 is a schematic diagram of a network learning process for image classification using attention-based multi-interaction network according to the present disclosure;

FIG. 2 is a schematic diagram of a prior module according to the present disclosure; and

FIG. 3 is a schematic diagram of a channel interaction module according to the present disclosure.

### DETAILED DESCRIPTION OF THE EMBODIMENTS

The present disclosure will be further described below with reference to the accompanying drawings and embodiments.

It should be noted that the following detailed description is exemplary and intended to provide further explanation of the present disclosure. Unless otherwise indicated, all technical and scientific terms used herein have the same meaning as commonly understood by one of ordinary skill in the art to which the present disclosure belongs.

It should be noted that the terminology used herein is for the purpose of describing specific embodiments only, and is not intended to limit the exemplary embodiments according to the present disclosure. As used herein, unless the context clearly dictates otherwise, the singular forms are intended to include the plural forms as well. It should also be understood that the terms “comprising” and/or “including”, when used in this specification, indicate that there are features, steps, operations, devices, components and/or combinations thereof.

According to the present disclosure, low-level visual features and high-level semantic features are fused by using a U-net network structure. An attention network is introduced to solve the problem of weak feature discrimination, and high attention is assigned to discriminative features, so that the discriminative features play an important role in the final classification process.

A sufficient multi-modal interaction mechanism is introduced, so that more effective correlation information and discriminative information can be obtained among multiple modalities, and sufficient interaction among the multiple modalities can be completed. Specifically, (1) in a prior module, prior knowledge of multiple modalities is used to calculate correlations among modalities and the unimodal information is enhanced to complete the first interaction among modalities; (2) in a channel interaction module, after the unimodal features are enhanced, features of the multiple modalities are fused in a channel dimension; (3) in a modality fusion module, features with correlation and fused modality are modeled to obtain features of attention areas of respective modalities, and then similarities are calculated, and areas with high similarity scores are weighted to obtain unimodal features with a high discrimination. This thus effectively guides the network to focus on more critical areas for classification tasks. Thereby, the third interaction among modalities is completed.

### Embodiment 1

This embodiment provides a multi-modal image classification system using an attention-based multi-interaction network, which includes a data acquisition module, a data preprocessing module, a data feature vector extraction module, a U-net feature extraction module, a prior module, a channel interaction module, a modality fusion module and an image classification module.

The data acquisition module is configured to acquire a multi-modal image. In this embodiment, a diffusion-weighted imaging image and an apparent diffusion coefficient image in magnetic resonance imaging are adopted.

The data preprocessing module includes a data enhancement processing module, a data set division module and a normalization processing module.

The data enhancement processing module is configured to perform random cropping, random rotating, scaling, translating, dithering, adding salt-pepper noise and Gaussian noise, and Gaussian blurring on a multi-modal data set. For enhanced data, it shall be ensured that each type of data is roughly balanced.

The normalization processing module is configured to perform a uniform scale transformation on samples processed by the data enhancement processing module. The original data samples may have inconsistent image sizes, and thus need to be transformed into being of a uniform size, for subsequent uniform normalization.

The data set division module is configured to divide the multi-modal data set processed by the normalization processing module into a training set, a verification set and a test set according to a certain ratio, such as 7:2:1.

The feature vector extraction module is configured to receive the multi-modal image preprocessed by the data preprocessing module, and load and input it into a feature extraction network, to extract key feature information vectors of the multi-modal image through operations such as a shallow convolution neural network, pooling, an activation function and the like, and in turn obtain a feature set A{A1, A2, A3 . . . Ai} of the multi-modal image, where i denotes a number of modalities.

The U-net feature extraction module is configured to receive the feature set A, and fuse low-level visual features and high-level semantic features in the feature set A by using U-net multi-resolution feature fusion, thereby further improving the distinguishability of features. After passing through encoder and experiencing the channel rearrangement operation, a feature map set B{B1, B2, B3 . . . Bi} is obtained, where i denotes a number of modalities.

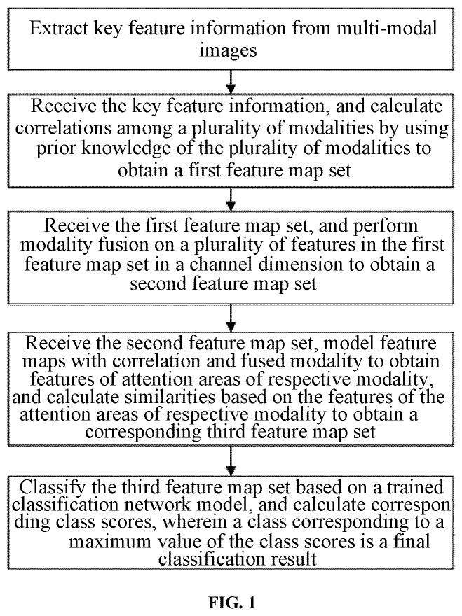

In the U-net, through partial convolution, low-level visual features can be extracted, and as the process proceeds to the deeper convolution layers, high-level semantic features can be extracted. As can be seen from FIG. 1, the low-level features and the high-level features are added, so that the fusion of the low-level visual features and the high-level semantic features can be implemented. The advantage of the above technique is that the low-level visual features and the high-level semantic features are fused by using the U-net network structure.

The prior module is configured to learn the similarities among multiple modalities by constructing a correlation learning module, so as to complete the first interaction among the modalities. For the set B, correlation scores among them are calculated by using a modified cosine function to obtain a feature map set C{C1, C2, C3 . . . Ci}, and areas with higher correlation are assigned with higher attentions to obtain a feature map set D{D1, D2, D3 . . . Di}.

The advantage of the above technique is that the attention network is introduced to solve the problem of weak feature discrimination, and higher attention is assigned to discriminative features, so that the discriminative features plays an important role in the final classification process.

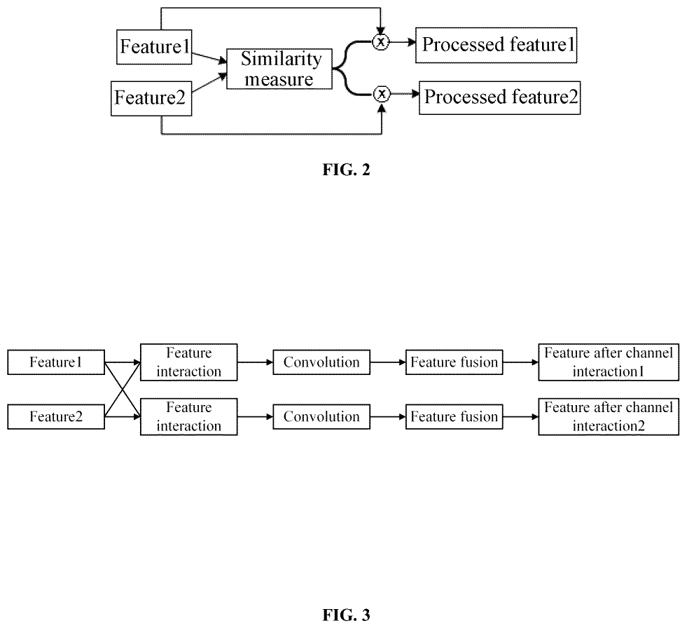

As shown in FIG. 2, the similarity between two modalities is learned by constructing a correlation learning module, so as to complete the first interaction among modalities.

In a first step, a correlation score between them is calculated using the modified cosine function:

$${S}_{1} = {( \frac{{x}_{i} - {μ}_{1}}{{‖ {x}_{i} - {μ}_{1} ‖}_{2}} )}^{T} ( \frac{{y}_{j} - {μ}_{2}}{{‖ {y}_{j} - {μ}_{2} ‖}_{2}} ) ,$$

$${S}_{2} = {( \frac{{y}_{i} - {μ}_{2}}{{‖ {y}_{i} - {μ}_{2} ‖}_{2}} )}^{T} ( \frac{{x}_{j} - {μ}_{2}}{{‖ {x}_{j} - {μ}_{1} ‖}_{2}} ) .$$

where xᵢ represents a first modality feature map, i=1 . . . n, n is a number of input images, μ₁ represents a mean value of the first modality feature maps, yⱼ represents a second modality feature map, and μ₂ represents a mean value of the second modal feature maps.

After the feature maps S1 and S2 are obtained, areas with higher correlation are assigned with higher attention to obtain feature maps A1 and A2. The resultant S1 denotes the correlation score between the two modalities, and when the score is high, it means that the correlation is high; and when the score is low, it means that the correlation is low. Since only among some parts of the input image, there exists correlation, the score may be high or low.

The weighting can be performed by dot product between y and the whole S1 calculated using the correlation score. Two modalities are taken as examples to illustrate the calculation process.

B1 and B2 are first normalized to obtain fa and fb, channel rearrangement is performed on fa to obtain fa′, and a dot product result between fa′ and f2 is denoted as S1 (correlation score 1).

Similarly, channel rearrangement is performed on fb to obtain fb′, the dot product result between fb′ and fa is denoted as S2 (correlation score 2).

Dot product between x and S2 calculated using the correlation score yields A1, and dot product between S2 and y yields A2.

The channel interaction module is configured to pass the feature maps A1 and A2 through the decoder, perform, on the feature maps A1 and A2, high-low dimensional feature fusing and modality interaction in the channel dimension, to obtain feature maps yD and yA.

Two loss functions are added to allow the fused modality features to be more conducive to classification, and the loss functions may be defined as Loss1 and Loss2.

As shown in FIG. 3, the feature maps A1 and A2 are passed through the decoder, and are subjected to the high-low dimensional feature fusion, and the modality interaction in the channel dimension:

xₘ^{l}=C([x₁^{l-1},x₂^{l-1},xₘ¹]),

where x₁^{l} and x₂^{l} represents the output of the 1-th feature map for modality 1 and modality 2 respectively, and C represents connection operation between the channels.

The modality fusion module is configured to input the features yD and yA into the modality fusion module, obtain two feature matrices D1 and D2 and two feature matrices A1 and A2 through a 1×1 convolution, and multiply the two feature matrices D1 and D2 to obtain the feature D and multiply the two feature matrices A1 and A2 to obtain the feature A. A similarity between D and A is calculated, and similarity area features are weighted, and are added to the original features to obtain a new feature with global context information.

The features yD and yA are input into the modality fusion module, two feature matrices D1 and D2 and two feature matrices A1 and A2 are obtained by a 1×1 convolution, and the two feature matrices D1 and D2 are multiplied to obtain the feature D and the two feature matrices A1 and A2 are multiplied to obtain the feature A. The similarity between D and A is calculated by using the cosine function:

$${R}_{A} = {( \frac{{D}_{i}}{{‖ {D}_{i} ‖}_{2}} )}^{T} ( \frac{{A}_{j}}{{‖ {A}_{j} ‖}_{2}} ) ,$$

$${R}_{D} = {( \frac{{A}_{i}}{{‖ {A}_{i} ‖}_{2}} )}^{T} ( \frac{{D}_{j}}{{‖ {D}_{j} ‖}_{2}} ) ,$$

and then, the similarity area features are weighted, and are added to the original features to obtain a new feature with global context information.

The multi-modal interaction module is configured to calculate correlations among multiple modalities by using prior knowledge of the modalities, fuse the features of the multiple modalities in the channel dimension, model the features with correlation and fused modality to obtain features of attention areas in respective modalities, and calculate the similarities based on the features of the attention areas in respective modalities to obtain a corresponding discriminative unimodal feature.

After the feature extraction is completed in three interaction modules, multi-modal features are concatenated, to make preparation for calculating a final total loss.

The advantage of the above technology is that, by introducing a sufficient multi-modal interaction mechanism, more effective correlation information and discriminative information are obtained among multiple modalities, and sufficient interaction among the multiple modalities is completed.

In step S8,the total loss of the channel interaction module is calculated.

The loss is a sum of losses of multiple modality. Taking two modalities as an example in the present disclosure, Loss (channel) =L1+L2:

Ln=−(yₙ·log(ŷₙ)+(1−yₙ)log(1−ŷₙ)),

where n=1,2. The feature learning process is constrained by minimizing this loss, so that the learned features are more conducive to classification.

In step S9, network training is performed.

A sum of the cross-entropy loss and the total loss of the interaction module is taken as the total loss of a network model:

L_{f}=−(y·log(ŷ)+(1−y)log(1−ŷ)),

where L=L (channel)+L_{f}. Back-propagation training is repeated until a preset number of epochs is reached. The network model with a minimum loss value is reserved.

In step S10, prediction process is performed.

The multi-modal image is input into a trained network model for prediction, to obtain corresponding class scores, and a class corresponding to a maximum value of the class scores is the prediction result.

Taking two modalities as an example in the present disclosure, a loss calculation module of the multi-modal channel interaction module is configured that the loss is a sum of losses of the two modalities, Loss (channel)=L1+L2:

Ln=−(yₙ·log(ŷₙ)+(1−yₙ)log(1−ŷₙ)),

where n=1, 2. The feature learning process is constrained by minimizing this loss, so that the learned features are more conducive to classification.

### Embodiment 2

This embodiment provides a multi-modal image classification method using an attention-based multi-interaction network, which includes the following steps 1-5.

In step 1, key feature information is extracted from a multi-modal image.

In step 2: based on the key feature information, correlations among multiple modalities are calculated by using prior knowledge of the multiple modalities to obtain a first feature map set.

In step 3: based on the first feature map set, modality fusion is performed on multiple features in the first feature map set in a channel dimension, so as to obtain a second feature map set.

In step 4, based on the second feature map set, feature maps with correlation and fused modality are modeled to obtain features of attention areas in respective modalities, and similarities are calculated based on the features of the attention areas in respective modalities to obtain a corresponding third feature map set.

In step 5, the third feature map set is classified based on a trained classification network model, and corresponding class scores are calculated, where a class corresponding to a maximum value of the class scores is a final classification result.

In step 1, data enhancement processing includes: performing random cropping, random rotating, scaling, translating, dithering, adding salt-pepper noise and Gaussian noise, and Gaussian blurring on a data set. For enhanced data, it shall be ensured that each type of data is roughly balanced.

Data set dividing includes dividing the data set into a training set, a verification set and a test set according to a certain ratio, such as 7:2:1.

Normalization processing includes performing a uniform scale transformation on existing data sets to transform them into being of a uniform size, and performing a uniform normalization processing.

Effectiveness of the method according to the present disclosure is verified on a multi-modal breast cancer data set.

The following evaluation indices are used:

$$ACC = \frac{T P + T N}{T P + T N + F P + F N} , \qquad ( 1 )$$

$$SEN = \frac{T P}{T P + F N} , \qquad ( 2 )$$

$$SPC = \frac{T N}{T N + F P} , \qquad ( 3 )$$

$$AUC = {\int }_{0}^{1} TPR ( F ) d ( F ) , \qquad ( 4 )$$

where ACC represents the proportion of the number of samples correctly predicted by the classifier to the total number of samples; SEN represents the proportion of the number of positive samples correctly predicted by the classifier to the total number of positive samples; SPC represents the proportion of the number of negative samples correctly predicted by the classifier to the total number of negative samples; and AUC is an evaluation index to measure the advantages and disadvantages of a binary classification model.

TP represents the number of malignant tumors which are predicted to be malignant tumors; TN represents the number of benign tumors which are predicted to be benign tumors; FP represents the number of benign tumors which are predicted to be malignant tumors; and FN represents the number of malignant tumors which are predicted to be benign tumors. TPR stands for true positive rate, which is defined as TPR=TP/(TP+FN), and F is false positive rate, which is defined as FPR=FP/(TN+FP).

Compared with classification results of other multi-modal methods, the experimental results are shown in Table 1.

TABLE 1
Comparison with classification results of other multi-modal methods

| Method | ACC | AUC | SPC | SEN |
|---|---|---|---|---|
| DEM (Method 1) | 83.3 ± 3.0 | 83.4 ± 2.8 | 90.0 ± 6.1 | 81.7 ± 8.2 |
| SSMN | 83.2 ± 3.7 | 83.3 ± 3.6 | 82.1 ± 8.1 | 84.3 ± 10.2 |
| (Method 2) | | | | |
| MFCNN | 76.3 ± 1.8 | 76.5 ± 2.1 | 90.0 ± 7.1 | 60.0 ± 14.1 |
| (Method 3) | | | | |
| FW-Net | 83.1 ± 1.3 | 83.1 ± 1.3 | 86.3 ± 12.5 | 80.0 ± 12.9 |
| (Method 4) | | | | |
| Method of the | 87.0 ± 3.3 | 87.0 ± 3.3 | 88.0 ± 5.7 | 86.0 ± 4.2 |
| present disclosure | | | | |

The result comparison shows that the classification effect of the present disclosure is superior to that of other multi-modal classification methods.

The foregoing is merely preferable embodiments of the present disclosure, and is not intended to limit the present disclosure. Various modifications and variations of the present disclosure will be apparent to those skilled in the art. Any modification, equivalent replacement, improvement, etc. made within the spirit and principle of the present disclosure shall be included within the protection scope of the present disclosure.

What is claimed is:

1. A multi-modal image classification system using an attention-based multi-interaction network, comprising:
a feature vector extraction module configured to extract key feature information from multi-modal images;
a prior module configured to receive the key feature information, and calculate correlations among a plurality of modalities by using prior knowledge of the plurality of modalities, to obtain a first feature map set;
a channel interaction module configured to receive the first feature map set, and perform modality fusion on a plurality of features in the first feature map set in a channel dimension to obtain a second feature map set;
a modality fusion module configured to receive the second feature map set, model feature maps with correlation and fused modality to obtain features of attention areas of respective modalities, and calculate similarities based on the features of the attention areas of respective modalities, to obtain a corresponding third feature map set;
an image classification module configured to classify the third feature map set based on a trained classification network model, and calculate corresponding class scores, wherein a class corresponding to a maximum value of the class scores is a final classification result.

2. The multi-modal image classification system according to claim 1, wherein the system further comprises a U-net feature extraction module configured to receive the key feature information, and fuse low-level visual features and high-level semantic features in the key feature information by using U-net multi-resolution feature fusion.

3. The multi-modal image classification system according to claim 1, wherein the system further comprises a data preprocessing module, and the data preprocessing module comprises a data enhancement processing module, a data set division module and a normalization processing module.

4. The multi-modal image classification system according to claim 1, wherein the prior module is configured to learn similarities among the plurality of modalities by constructing a correlation learning model, which comprises:
calculating correlation scores among the plurality of modalities by using a modified cosine function;
screening out areas with high correlation according to the correlation scores and assigning the areas with higher attention.

5. The multi-modal image classification system according to claim 1, wherein the modality fusion module is configured to perform channel rearrangement on the multi-modal images after normalization operation, to obtain correlation scores; pass the feature maps through a decoder and perform, on the feature maps, high-low dimensional feature fusion and modality interaction in the channel dimension, by using the correlation scores.

6. A multi-modal image classification method using an attention-based multi-interaction network, comprising:
extracting key feature information from multi-modal images;
calculating, based on the key feature information, correlations among a plurality of modalities by using prior knowledge of the plurality of modalities, to obtain a first feature map set;
performing, based on the first feature map set, modality fusion on a plurality of features in the first feature map set in a channel dimension to obtain a second feature map set;
modeling, based on the second feature map set, feature maps with correlation and fused modality to obtain features of attention areas of respective modalities, and calculating similarities based on the features of the attention areas of respective modalities to obtain a corresponding third feature map set;
classifying the third feature map set based on a trained classification network model, and calculating corresponding class scores, wherein a class corresponding to a maximum value of the class scores is a final classification result.

7. The multi-modal image classification method according to claim 6, wherein the method comprises fusing low-level visual features and high-level semantic features in the key feature information by using U-net multi-resolution feature fusion after extracting the key feature information.

8. The multi-modal image classification method according to claim 6, wherein the method comprises performing preprocessing on the multi-modal images before extracting the key feature information, and the preprocessing comprises data enhancement processing, data set division processing and normalization processing.

9. The multi-modal image classification method according to claim 6, wherein the calculating similarities based on the features of the attention areas of the respective modalities is to learn similarities among the plurality of modalities by constructing a correlation learning model, which comprises:
calculating correlation scores among the plurality of modalities by using a modified cosine function;
screening out areas with high correlation according to the correlation scores and assigning the areas with higher attention.

10. The multi-modal image classification method according to claim 6, wherein the method comprises performing channel rearrangement on the multi-modal images after normalization operation to obtain correlation scores, and passing the feature maps through a decoder and performing, on the feature maps, high-low dimensional feature fusion and modality interaction in the channel dimension, by using the correlation scores.
